(19) United States
(12) Patent Application Publication
(10) Pub. No.: US 2026/0328133 A1
(43) Pub. Date: Oct. 22, 2026

(54) Turbine Housing Wastegate Spindle Bushing

(71) Applicant: BorgWarner Inc., Auburn Hills, MI (US)

(72) Inventor: Christian Charles Longacre, Arden, NC (US)

(73) Assignee: BorgWarner Inc., Auburn Hills, MI (US)

(21) Appl. No.: 19/180,734

(22) Filed: Apr. 16, 2025

(51) Int. Cl. F02B 37/18; F01D 17/10

(52) U.S. Cl. CPC F02B 37/183; F01D 17/105; F05D 2220/40; F05D 2260/606

(57) ABSTRACT

A spindle bushing configured to be used in conjunction with a wastegate spindle in a turbine housing of a turbocharger, including a spindle body formed as a cylindrical tube with a first outer diameter and an inner diameter, the spindle body including a first spindle end and a second spindle end, a shoulder formed at the second spindle end, the shoulder including a second outer diameter larger than the first outer diameter, a central spindle portion on the spindle body between the first spindle end and the second spindle end, the central spindle portion including a third outer diameter larger than the first outer diameter and smaller than the second outer diameter, a length of the central bushing portion being smaller than a bushing length of the bushing body.

### TECHNICAL FIELD

The present disclosure generally relates to turbochargers, and more specifically relates to wastegates of turbochargers.

### BACKGROUND

Turbochargers are used in various industries as power-adding components of internal combustion engines. Turbochargers may be generally provided with a shaft enveloped by a center housing with a compressor wheel and a turbine wheel at opposite ends of the shaft. The compressor wheel may be housed within a compressor housing with an inlet and an outlet, and the turbine wheel may be housed within a turbine housing having an inlet and an outlet.

In operation, hot exhaust gases from the engine attached to the turbocharger may enter the turbocharger through the inlet on the turbine housing, interact with blades of the turbine wheel, and exit the turbocharger through the outlet of the turbine housing. The exhaust gases may then be directed away from the engine and the turbocharger via an exhaust system. Interaction of the exhaust gas flow with the turbine wheel causes rotation of the turbine wheel, and thus rotates the shaft, which in turn rotates the compressor wheel. Air may enter the inlet of the compressor housing, may be compressed by interaction with the compressor wheel, and may leave the turbocharger via the outlet of the compressor housing, where it may then be provided to the engine through an intake system.

A key component of a turbocharger is the wastegate, which regulates exhaust gas flow to control boost pressure. Wastegates may either be internal wastegates, integrated within the turbocharger housing, or external wastegates, provided externally to the turbocharger. Internal wastegates offer packaging and cost advantages over external wastegates. In an internal wastegate, a wastegate valve is located proximate a turbine outlet within a turbine housing, and is actuated by a wastegate spindle that extends into the turbine housing.

An important element in the internal wastegate assembly is a spindle bushing, which provides rotational support for the wastegate spindle. The spindle bushing must withstand high temperatures, friction, and thermal expansion while maintaining low wear and resistance to deformation. Conventional spindle bushings, typically made from metal alloys or coated materials, are configured to have an interference fit with an opening in the turbine housing. Pressing these spindle bushings into the turbine housing can cause a burr of material to form, either on the turbine housing or the spindle bushing. This burr of excess material can cause displacement of the spindle bushing toward the wastegate spindle, thereby causing the bushing to gall and seize.

There remains a need for an improved spindle bushing design that facilitates precise installation, thereby extending the operational lifespan of the turbocharger wastegate system.

### SUMMARY OF THE DISCLOSURE

In accordance with one aspect of the disclosure, a turbine housing for a turbocharger may be provided. The turbine housing may comprise a turbine inlet and a turbine outlet for receiving and removing an exhaust gas flow about a turbine wheel, and a wastegate port within the turbine outlet proximate the turbine wheel, for diverting the exhaust gas flow to avoid the turbine wheel. The turbine housing may comprise a wastegate spindle connected to a wastegate valve, the wastegate spindle extending through a spindle hole in the turbine outlet and configured to actuate the wastegate valve to open and close the wastegate port. The turbine housing may comprise a spindle bushing disposed between the spindle hole and the wastegate spindle. The spindle bushing may include a bushing body formed as a cylindrical tube with a first outer diameter, an inner diameter, a first bushing end, and a second bushing end. The spindle bushing may include a shoulder formed at the second bushing end, including a second outer diameter larger than the first outer diameter.

The spindle bushing may include a central bushing portion on the bushing body between the first bushing end and the second bushing end, including a third outer diameter larger than the first outer diameter and smaller than the second outer diameter. The spindle bushing may include a length of the central bushing portion being smaller than a bushing length of the bushing body.

In accordance with another aspect of the disclosure, a spindle bushing configured to be used in conjunction with a wastegate spindle in a turbine housing of a turbocharger may be provided. The spindle bushing may comprise a bushing body formed as a cylindrical tube with a first outer diameter and an inner diameter, the bushing body including a first bushing end and a second bushing end. The spindle bushing may comprise a shoulder formed at the second bushing end, the shoulder including a second outer diameter larger than the first outer diameter. The spindle bushing may comprise a central bushing portion on the bushing body between the first bushing end and the second bushing end, the central bushing portion including a third outer diameter larger than the first outer diameter and smaller than the second outer diameter. The spindle bushing may comprise a length of the central bushing portion being smaller than a bushing length of the bushing body.

In accordance with yet another aspect of the disclosure, a method of assembling a turbine housing of a turbocharger may be provided. The method may comprise providing the turbine housing including a turbine inlet and a turbine outlet to direct an exhaust gas flow about a turbine wheel, and a wastegate port within the turbine outlet for diverting the exhaust gas flow to avoid the turbine wheel, the turbine outlet including a spindle hole. The method may comprise pressing a spindle bushing into the spindle hole. The spindle bushing may include a bushing body formed as a cylindrical tube with a first outer diameter, an inner diameter, a first bushing end, and a second bushing end, a shoulder formed at the second bushing end, including a second outer diameter larger than the first outer diameter, and a central bushing portion on the bushing body between the first bushing end and the second bushing end, including a third outer diameter larger than the first outer diameter and smaller than the second outer diameter, a length of the central bushing portion being smaller than a bushing length of the bushing body. The method may comprise the central bushing portion fitting against an inside wall of the spindle hole and the shoulder resting against an outer surface of the spindle hole.

These and other aspects and features of the present disclosure will be more readily understood when read in conjunction with the accompanying drawings.

### BRIEF DESCRIPTION OF THE DRAWINGS

FIG. 1 is a side view of a turbocharger constructed in accordance with an embodiment of the present disclosure.

FIG. 2 is a side view of a turbine housing constructed in accordance with an embodiment of the present disclosure.

FIG. 3 is a cross-section view of a wastegate spindle constructed in accordance with an embodiment of the present disclosure.

FIG. 4 is a perspective view of a spindle bushing constructed in accordance with an embodiment of the present disclosure.

FIG. 5 is a perspective view of a wastegate spindle constructed in accordance with an embodiment of the present disclosure.

FIG. 6 is a flowchart depicting a sample sequence of steps for assembling a turbine housing of a turbocharger, which may be practiced in accordance with the turbine housing of the present disclosure.

The figures depict one embodiment of the presented invention for purpose of illustration only. One skilled in the art will readily recognize form the following discussion that alternative embodiments of the structures and method illustrated herein may be employed without departing form the principles described herein.

### DETAILED DESCRIPTION

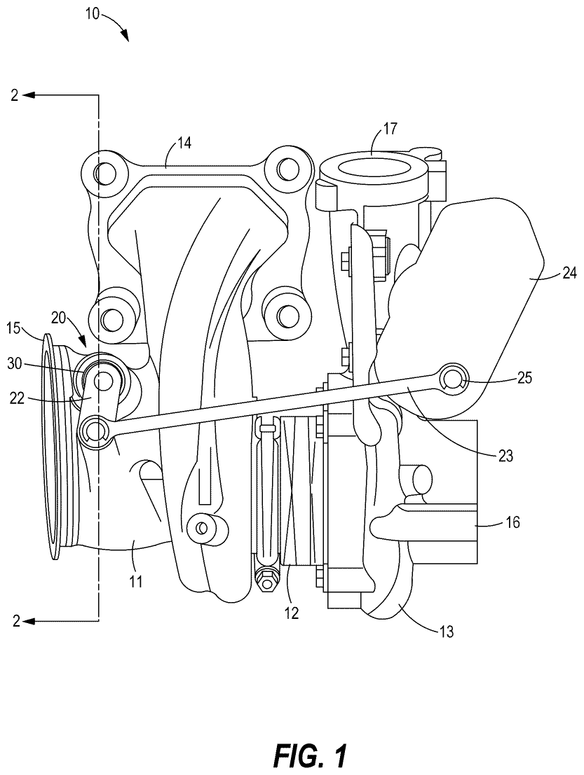

Referring now to the drawings, and with specific reference to FIG. 1, a turbocharger is depicted and generally referred to using reference numeral 10. The turbocharger 10 as depicted and described in may be used in conjunction with an automobile, and can also find applicability with other machines such as trucks and power generators.

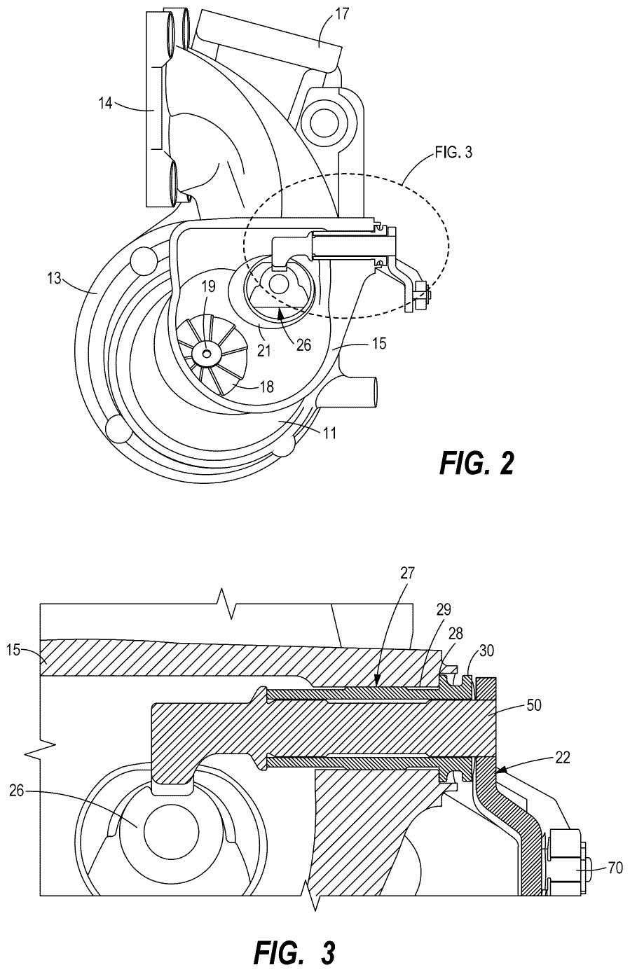

The turbocharger 10 is shown schematically in FIG. 1. The turbocharger 10 may be formed of a turbine housing 11 for housing a turbine wheel 18 (FIG. 2), a compressor housing 13 for housing a compressor wheel (not depicted), and a center housing 12 for housing a shaft 19 (FIG. 2) connecting the turbine wheel 18 and the compressor wheel.

The compressor housing 13 may define a compressor inlet 16, from where ambient air may enter the turbocharger 10, and a compressor outlet 17, where compressed air may leave the compressor housing 13, eventually routed to an air intake of an engine.

Similarly, the turbine housing 11 may comprise a turbine inlet 14 and a turbine outlet 15 for receiving and removing an exhaust gas flow about the turbine wheel 18. As the turbine wheel 18 spins, it drives the compressor wheel to spin. As the compressor wheel increases its speed, increased air pressure is delivered to the engine through the compressor outlet 17.

In order to control the increased (boost) pressure, the turbine housing 11 may comprise a wastegate 20. The wastegate 20 may be actuated by a crank arm 22. The crank arm 22 may be actuated by an actuator link 23 connected to the crank arm 22 at a first link end and a wastegate actuator 24 at a second link end. The crank arm 22 may include a post 70 (FIG. 3) that the actuator link 23 may be disposed on.

Similarly, the wastegate actuator 24 may include a complementary post (not depicted) to attach the actuator link. A clip 25 may be provided to secure the actuator link 23 to the post 70 of the crank arm 22 and the complementary post of the wastegate actuator 24. The wastegate actuator 24 is depicted as an electronic actuator, however, the wastegate actuator 24 may be a pneumatic actuator, or any actuator as known. As depicted in FIG. 1, the wastegate actuator 24 may be mounted onto the compressor housing 13 of the turbocharger 10. However, the wastegate actuator 24 may be placed in any other location on the turbocharger 10 as required.

FIGS. 2-3 illustrate a cross-section view of the wastegate 20 of the turbocharger 10. The wastegate 20 may include a wastegate port 21 within the turbine outlet 15 proximate the turbine wheel 18, for diverting the exhaust gas flow to avoid the turbine wheel 18. The wastegate 20 may comprise a wastegate spindle 50 connected to a wastegate valve 26, the wastegate spindle 50 extending through a spindle hole 27 in the turbine outlet 15 and configured to actuate the wastegate valve 26 to open and close the wastegate port 21.

As depicted in FIG. 3, the wastegate spindle 50 extends through the spindle hole 27 in the turbine outlet 15 and is connected to the crank arm 22. The crank arm 22 may be configured to deliver a rotational movement to the wastegate spindle 50, thereby actuating the wastegate valve 26. In order to facilitate rotation of the wastegate spindle 50, a spindle bushing 30 may be disposed between the spindle hole 27 and the wastegate spindle 50. The spindle hole 27 may have an inside wall 29 sized such that pressing the spindle bushing 30 into the spindle hole 27 forms an interference fit. The spindle bushing 30 may be pressed into the spindle hole 27 such that the spindle bushing 30 rests against an outer surface 28 of the spindle hole.

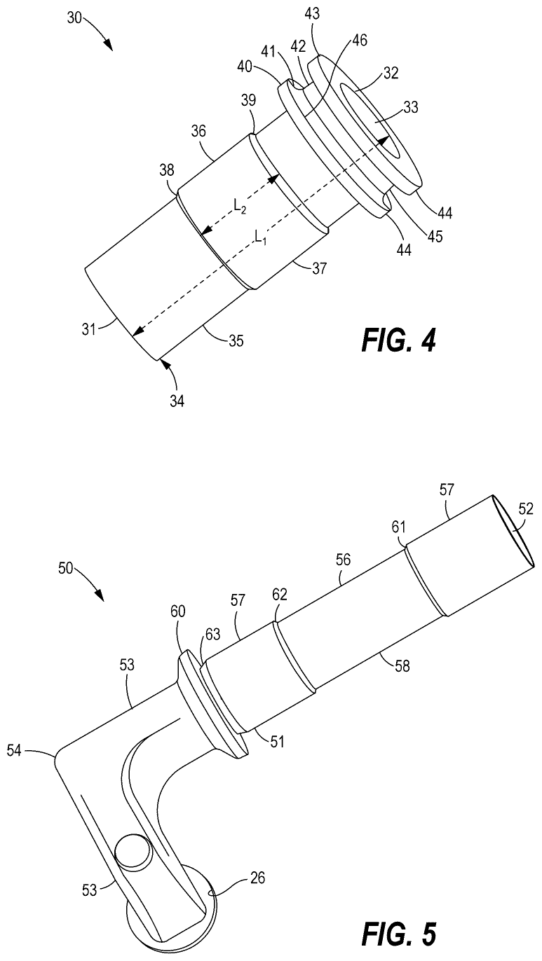

FIG. 4 depicts a perspective view of the spindle bushing 30. The spindle bushing 30 may comprise a bushing body 34 formed as a cylindrical tube with a first outer diameter 35 and an inner diameter 33, the bushing body 34 including a first bushing end 31 and a second bushing end 32. The inner diameter 33 may be sized to receive the wastegate spindle 50 and allow rotational movement of the wastegate spindle 50 within the spindle bushing 30. The spindle bushing 30 may be constructed from a steel-based metal material. The spindle bushing 30 may be steel, a steel alloy, a stainless steel, or may be any other material as required.

The spindle bushing 30 may comprise a shoulder 40 formed at the second bushing end 32, the shoulder 40 including a second outer diameter 44 larger than the first outer diameter 35. The shoulder 40 may be configured such that when the spindle bushing 30 is pressed into the spindle hole 27, the shoulder 40 rests against the outer surface 28 of the spindle hole 27. The shoulder 40 may include a first shoulder portion 41, a second shoulder portion 42, and a third shoulder portion 43. The first shoulder portion 41 and the third shoulder portion 43 may be sized having the second outer diameter 44. The second shoulder portion 42 may be sized having a fourth outer diameter 45, the fourth outer diameter 45 being smaller than the second outer diameter 44. The shoulder 40 may also include a shoulder radius 46 at a transition between the first shoulder portion 41 and the second shoulder portion 42, and between the second shoulder portion 42 and the third shoulder portion 43.

The spindle bushing 30 may comprise a central bushing portion 36 on the bushing body 34 between the first bushing end 31 and the second bushing end 32. The central bushing portion 36 may include a third outer diameter 37 larger than the first outer diameter 35 and smaller than the second outer diameter 44. The third outer diameter 37 may also be sized such that it is smaller than the fourth outer diameter 45. The length L₂ of the central bushing portion 36 may also be smaller than a bushing length L₁ of the bushing body 34. As depicted, the central bushing portion 36 may therefore be sized such that it is contained on only a small portion of the bushing body 34. As depicted, the spindle bushing 30 is sized such that the first outer diameter 35 is smaller than the diameter of the spindle hole 27, and the third outer diameter 37 is slightly larger than the diameter of the spindle hole 27. As such, the spindle bushing 30 may be required to be pressed into the spindle hole 27, forming an interference fit. Having the central bushing portion 36 on only a small portion of the bushing body 34 reduces the chance of galling of the central bushing portion 36 when the spindle bushing 30 is pressed into the spindle hole 27. The spindle bushing 30 may also comprise a chamfer between the bushing body 34 and the central bushing portion 36 at each end of the central bushing portion 36 shown as a first chamfer 38 and a second chamfer 39. The first chamfer 38 and the second chamfer 39 may serve to further increase ease of installation of the spindle bushing 30, as well as to reduce the chance of galling.

FIG. 5 depicts the wastegate spindle 50 in a perspective view. The wastegate spindle 50 may also be a cylindrical body with a first spindle end 51 and a second spindle end 52. The wastegate spindle 50 may be connected to the wastegate valve 26 at the first spindle end 51, and connected to the crank arm 22 at the second spindle end 52. The wastegate spindle 50 may be configured to transmit rotational movement of the crank arm 22 from outside the turbine outlet 15 to the wastegate valve 26 inside the turbine outlet 15. The first spindle end 51 may include a first valve arm 53, a bend 54, a second valve arm 55, and a spindle shoulder 60. The spindle shoulder 60 may provide a stop for the wastegate spindle 50 against the first bushing end 31 as it is pressed into the spindle bushing 30.

The wastegate spindle 50 may also include a central spindle portion 56 between the first spindle end 51 and the second spindle end 52, the wastegate spindle 50 including a first spindle diameter 57 at the first spindle end 51 and the second spindle end 52, and a second spindle diameter 58 at the central spindle portion 56 smaller than the first spindle diameter 57. As depicted, chamfers may be provided at transition portions along the wastegate spindle 50 in order to facilitate ease of installation. A first spindle chamfer 61 and a second spindle chamfer 62 may be provided at a transition from the first spindle diameter 57 to the second spindle diameter 58. A third spindle chamfer 63 may be provided at a transition from the first spindle end 51 to the spindle shoulder 60.

The wastegate spindle 50 may also include a constant spindle diameter represented by the first spindle diameter 57 along the entire length from the first spindle end 51 to the second spindle end 52. The third spindle chamfer 63 may still be provided at the transition from the first spindle end 51 to the spindle shoulder 60 in order to provide for ease of installation.

### INDUSTRIAL APPLICABILITY

In operation, the teachings of the present disclosure can find applicability in many industries including but not limited to power generation, automotive, on and off highway trucking, mining, and construction industries. While depicted and described in conjunction with an automobile, such teachings can also find applicability with other machines that utilize turbocharger technology such as power generators, on and off trucks, and work machines as well.

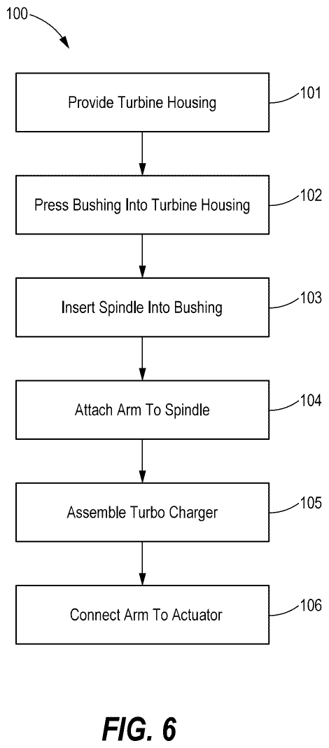

FIG. 6 illustrates a visual representation of a method of assembling the turbine housing 11 for the turbocharger 10. In a first step 101, the turbine housing 11 may be provided. The turbine housing 11 may include providing the turbine inlet 14 and the turbine outlet 15 to direct an exhaust gas flow about the turbine wheel 18, and providing the wastegate port 21 within the turbine outlet 15 for diverting the exhaust gas flow to avoid the turbine wheel 18, the turbine outlet 15 including the spindle hole 27.

In a second step 102, the spindle bushing 30 may be pressed into the spindle hole 27. The spindle bushing 30 may include the bushing body 34 formed as a cylindrical tube with the first outer diameter 35, the inner diameter 33, the first bushing end 31 and the second bushing end 32. The spindle bushing 30 may include the shoulder 40 formed at the second bushing end 32, including the second outer diameter 44 larger than the first outer diameter 35. The spindle bushing 30 may include the central bushing portion 36 on the bushing body 34 between the first bushing end 31 and the second bushing end 32. The central bushing portion 36 may include the third outer diameter 37 larger than the first outer diameter 35 and smaller than the second outer diameter 44. The length L₂ of the central bushing portion 36 may be smaller than the bushing length L₁ of the bushing body 34. The central bushing portion 36 may fit against the inside wall 29 of the spindle hole 27 and the shoulder 40 may rest against the outer surface 28 of the spindle hole 27. The inside wall 29 of the spindle hole 27 and the third outer diameter 37 of the central bushing portion 36 may be sized such that pressing the spindle bushing 30 into the spindle hole 27 forms an interference fit.

In a third step 103, the wastegate spindle 50 may be inserted through the spindle bushing 30. The wastegate spindle 50 may be connected to the wastegate valve 26 such that the wastegate spindle 50 may be configured to rotate and actuate the wastegate valve 26 to open and close the wastegate port 21 of the turbine housing 11. The wastegate spindle 50 may be disposed through the spindle bushing 30 by inserting the second spindle end 52 of the wastegate spindle 50 through the inner diameter 33 of the spindle bushing 30 until the spindle shoulder 60 comes into contact with the first bushing end 31.

In a fourth step 104, the wastegate spindle 50 may be locked into position by attaching the crank arm 22 to the second spindle end 52 of the wastegate spindle 50. The crank arm 22 may be attached by a press fit, as depicted, or may be attached through any other methods as required.

The turbocharger 10 may be assembled in a fifth step 105 by disposing the turbine housing 11 about the turbine wheel of the turbocharger 10. The turbine housing 11 and the compressor housing 13 may be directly attached to the center housing 12, and the wastegate actuator 24 may be attached to the compressor housing 13. Finally, in a sixth step 106, the crank arm 22 is connected to the wastegate actuator 24 by the actuator link 23. The actuator link 23 may be disposed on the post 70 of the crank arm and the complementary post of the wastegate actuator 24, and secured by the clip 25 on either end.

The method 100 of assembling the turbine housing 11 provides for installation of the spindle bushing 30 into the turbine housing 11 in a reliable manner. The shorter length of the central bushing portion 36 relative the bushing body 34 reduces the likelihood that the spindle bushing 30 will gall during installation, thereby preventing seizing of the wastegate spindle 50 during operation. Reducing failure of the wastegate spindle 50 reduces failure of the turbocharger 10, thereby allowing for reduced warranty costs, reduced downtime, increased bushing and turbocharger life, and improved noise, vibration, and harshness from the turbocharger.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

1. A turbine housing for a turbocharger, comprising:
a turbine inlet and a turbine outlet for receiving and removing an exhaust gas flow about a turbine wheel, and a wastegate port within the turbine outlet proximate the turbine wheel, for diverting the exhaust gas flow to avoid the turbine wheel;
a wastegate spindle connected to a wastegate valve, the wastegate spindle extending through a spindle hole in the turbine outlet and configured to actuate the wastegate valve to open and close the wastegate port; and
a spindle bushing disposed between the spindle hole and the wastegate spindle, the spindle bushing further including:
a bushing body formed as a cylindrical tube with a first outer diameter, an inner diameter, a first bushing end, and a second bushing end,
a shoulder formed at the second bushing end, including a second outer diameter larger than the first outer diameter,
a central bushing portion on the bushing body between the first bushing end and the second bushing end, including a third outer diameter larger than the first outer diameter and smaller than the second outer diameter, and a length of the central bushing portion being smaller than a bushing length of the bushing body.

2. The turbine housing of claim 1 wherein the wastegate spindle includes a crank arm, and the crank arm is actuated by an actuator link connected to the crank arm at a first link end and a wastegate actuator at a second link end.

3. The turbine housing of claim 2, wherein the wastegate actuator is an electronic actuator.

4. The turbine housing of claim 2, wherein the wastegate actuator is a pneumatic actuator.

5. The turbine housing of claim 2, wherein the wastegate actuator is mounted onto a compressor housing of the turbocharger.

6. The turbine housing of claim 1, wherein the wastegate spindle is a cylindrical body with a first spindle end and a second spindle end, the wastegate spindle connected to the wastegate valve at the first spindle end, and connected to a crank arm at the second spindle end, the wastegate spindle configured to transmit rotational movement of the crank arm from outside the turbine outlet to the wastegate valve inside the turbine outlet.

7. The turbine housing of claim 6, wherein the wastegate spindle includes a central spindle portion between the first spindle end and the second spindle end, the wastegate spindle including a first spindle diameter at the first spindle end and the second spindle end, and a second spindle diameter at the central spindle portion smaller than the first spindle diameter.

8. A spindle bushing configured to be used in conjunction with a wastegate spindle in a turbine housing of a turbocharger, comprising:
a bushing body formed as a cylindrical tube with a first outer diameter and an inner diameter, the bushing body including a first bushing end and a second bushing end;
a shoulder formed at the second bushing end, the shoulder including a second outer diameter larger than the first outer diameter; and
a central bushing portion on the bushing body between the first bushing end and the second bushing end, the central bushing portion including a third outer diameter larger than the first outer diameter and smaller than the second outer diameter, a length of the central bushing portion being smaller than a bushing length of the bushing body.

9. The spindle bushing of claim 8, further comprising a chamfer between the bushing body and the central bushing portion at each end of the central bushing portion.

10. The spindle bushing of claim 8, wherein the shoulder includes a first shoulder portion, a second shoulder portion, and a third shoulder portion, the first shoulder portion and the third shoulder portion sized having the second outer diameter, the second shoulder portion sized having a fourth outer diameter, the fourth outer diameter smaller than the second outer diameter and larger than the third outer diameter.

11. The spindle bushing of claim 10, including a shoulder radius at a transition between the first shoulder portion and the second shoulder portion, and between the second shoulder portion and the third shoulder portion.

12. The spindle bushing of claim 8, wherein the inner diameter is sized to receive the wastegate spindle and allow rotational movement of the wastegate spindle within the spindle bushing.

13. The spindle bushing of claim 8, wherein the spindle bushing is constructed from steel.

14. The spindle bushing of claim 8, wherein the spindle bushing is constructed from stainless steel.

15. A method of assembling a turbine housing for a turbocharger, comprising:
providing the turbine housing including a turbine inlet and a turbine outlet to direct an exhaust gas flow about a turbine wheel, and a wastegate port within the turbine outlet for diverting the exhaust gas flow to avoid the turbine wheel, the turbine outlet including a spindle hole; and
pressing a spindle bushing into the spindle hole, the spindle bushing including a bushing body formed as a cylindrical tube with a first outer diameter, an inner diameter, a first bushing end, and a second bushing end, a shoulder formed at the second bushing end, including a second outer diameter larger than the first outer diameter, and a central bushing portion on the bushing body between the first bushing end and the second bushing end, including a third outer diameter larger than the first outer diameter and smaller than the second outer diameter, a length of the central bushing portion being smaller than a bushing length of the bushing body.

16. The method of claim 15, wherein the inside wall of the spindle hole and the third outer diameter of the central bushing portion are sized such that pressing the spindle bushing into the spindle hole forms an interference fit.

17. The method of claim 15, further comprising disposing a wastegate spindle through the spindle bushing, the wastegate spindle connected to a wastegate valve configured to rotate and actuate the wastegate valve to open and close the wastegate port of the turbine housing.

18. The method of claim 17, wherein the wastegate spindle is a cylindrical body with a first spindle end and a second spindle end, the wastegate spindle connected to the wastegate valve at the first spindle end, the method further comprising the step of attaching a crank arm to the second spindle end.

19. The method of claim 18, further comprising disposing the turbine housing about the turbine wheel of the turbocharger.

20. The method of claim 19, further comprising connecting the crank arm to a wastegate actuator.
